(19) United States
(12) Patent Application Publication
(10) Pub. No.: US 2013/0000595 A1
(43) Pub. Date: Jan. 3, 2013

(54) Trigonometric linkage system

(76) Inventor: Michael D. Gilmartin, Broadmoor Village, CA (US)

(21) Appl. No.: 13/135,251

(22) Filed: Jun. 30, 2011

(51) Int. Cl. F02B 75/32

(52) U.S. Cl. 123/197.3

(57) ABSTRACT

Trigonal Linkage System replacing a single connecting rod system to a combination of two components (No. 1): a connecting link coupled to a guide piston (No. 2) which is without a solid top or bottom creating no pressure or vacuum and serves only as a guide for the power piston assembly, which prevents seizure moment on the main and crankpin journals, which will no longer be in inline formation at fuel mixture explosive impact moment.

### GLOSSARY AND ABBREVIATIONS

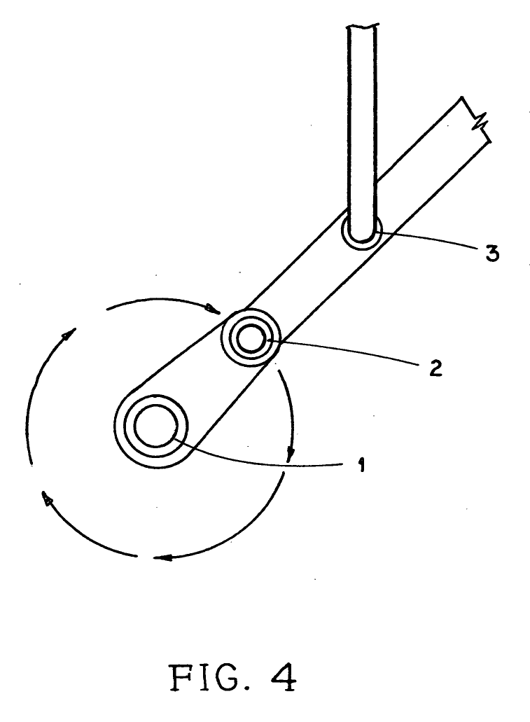

#1) ICE—internal combustion engine
#2) ECE—external combustion engine
#3) EFR—efficiency factor rating
#4) PFR—performance factor rating
#5) MPG—miles per gallon
#6) GPTM—gallons per ton-mile
#7) BMEP—brake mean effective pressure
#8) F1V10—Formula One GP V10 (3-liter engine)
#9) FIA—Federation Internationale de l'Automobile at 8 Place de Concorde, Paris, France
#10) TDC—Top Dead Center, 0°
#11) BDC—Bottom Center, 180°
#12) T.LS.—Trigonal Linkage System (Tri-gon-al) which refers or relates to, or belongs to a division of hexagonal crystal system, generally defined by a vertical (or in this specification, angular) axis of threefold symmetry (see Graphics FIG. 4)

### INDUSTRY STANDARD PRODUCTION I.C.E.

### Interpretation of Illustration

Piston at T.D.C., end of compression stroke, with fuel/air mixture properly combined and highly compressed, ready for detonation where explosive force is thrust upon the stationary piston (stationary or motionless since it is neither moving upward or downward until crankpin advances to approximately 25° plus after T.D.C. or 0°).

T.D.C. being the important or salient moment where maximum binding, or seizure moment occurs on three vertically inline journals A, B, and C, inducing enormous temporary friction losses and intense heat production, which tells us that another strategy is necessary. The only pragmatic solution to this dilemma would seem to be a suitable offline connecting linkage between piston wristpin journal A and crankpin journal B. It must be simple and structurally durable, easy to construct and require no additional scheduled servicing. The most expedient and practical application would be a trigonal linkage system (see Graphic FIG. 4), which can be an integral part of the I.C.E., of which only two extra basic components are integrated, namely one connecting link (rod), and one open-ended piston (excepting retainer, circlips, and washers). This will increase E.F.R. by at least double, and vastly reduce friction and excessive heat production.

### Fuel Choice & Evaluation

Be it known that I, Michael D. Gilmartin, resident of Broadmoor Village, San Mateo County, Calif. in the United States of America invented by careful study and a half-century of hands-on experience a new and unique component to the internal combustion engine with the determinative purpose of improving the efficiency factor rating of said internal combustion engine—the type used for transporting passengers, freight, liquid, etc. on land, water, air, or stationary service.

It is my belief that there is very little wrong with the fuel being used for the past thirty years: gasoline, petroleum spirit, the usual hydro-carbon fuel. Carbon monoxide, oxides of nitrogen, etc. should be reduced by fitting the trigonal linkage system and should be progressing towards a more inert state. This does not imply that the overall exhaust quantity will be devoid of inherent toxins but a very subdued noxious emission will be evident since also projected fuel intake will be reduced by at least 50%. (Refer to Fuels pg. 9 in this disclosure)

Heat and friction losses are not solely produced by oil pressurized journals, well-designed pistons, valve mechanisms, etc. Certainly these cause low grade friction, but not to a pitch where it absorbs 50% of power output. If that were so, an engine running at 18,000 RPM, as Formula One GPV8 High Performance engines do, would not have gained power output but would proportionally diminish energy production to zero output. So, it becomes obvious that power should be applied within a degree range where it will effect the greatest energetic force on the crankshaft and flywheel assembly and not where the piston has stopped motionless, (must stop to regain its rectilinear or reciprocal motion) on the third or power stroke the precise moment when the combustion is ignited. The explosive force is thrust upon the stationary piston, with crankpin and connecting rod in vertical position; motion is impossible. It is only by the rotational constancy of the flywheel that it will keep turning. Meanwhile, thermodynamic pressure is captive with no place to go. A potent and highly vigorous energy source, regretfully thermodynamic pressure is a fleeting and vanishing entity. It would be difficult to emphasize the swiftness with which this precious energy source decreases or diminishes, by losses, to heating the surrounding metals, rapidly expanding combustion space by piston travel and the natural temperature recession to ambient. The result crankshaft, binding or seizure moment and seizure period that last until the crank reaches 25° clockwise after T.D.C. The task for the constructor is to retrain or harness this energy at its most efficacious moment.

I propose the application of a trigonal linkage system. A suitable apposite and effective attachment or coupling can be made by engineer or constructor's judgment.

### Heat, Pressure, and Thermodynamic Energy

An I.C.E. does not derive a useful power application from explosive impact, when it occurs at T.D.C., where crankpin journal is in vertical or perpendicular dimension. This impact unfortunately causes a severe seizure moment that extends, or becomes a seizure period or binding until the crankpin journal reaches a more vantage or prevalent angle which is at least 25° clockwise after T.D.C, (90° clockwise being the optimum or prevalent leverage crankpin angle). Thermodynamic pressure is the main and only energetic source to drive the crankshaft-flywheel assembly, but a very potent and vigorous one; Regretfully, this source, (thermodynamic pressure) is a fleeting and vanishing entity due to the highly polarized temperature differential between energy source and combustion chamber. It is difficult to emphasize the swiftness with which this thermodynamic pressure decreases or diminishes, by losses to heating surrounding metals, rapidly expanding combustion space, and the natural temperature recession to ambient. It is only by stabilizing constancy of the flywheel that it salvages a decimated energy. So at its highest and most efficacious moment it must be harnessed to the best of the constructor's ability. Initially, it is not a lacking or weakness in BMEP that is the problem, it is the means by which it is applied. Thermodynamic pressure is a very potent and dynamic force, but a rapidly diminishing one, if not captured and harnessed with the utmost haste.

### Patents Prior Art Searched and Reviewed

1) United States Patent—Bailey
U.S. Pat. No. 6,463,895B2
Date of Patent: Oct. 15, 2002

2) United States patent—Niethammer et. al
U.S. Pat. No. 6,293,252B1
Date of Patent: Sep. 25, 2001

3) United States Patent—Schaeffer
U.S. Pat. No. 6,931,845B2
Date of Patent: Aug. 23, 2005

4) International Patent Classification: 6F02B/75/28
International Publication Number: WO98109061
International Publication Date: Mar. 5, 1998

5) United States Patent—James O. Casady
Internal Combustion Engine
U.S. Pat. No. 1,372,216
Application Date: Mar. 12, 1919
Patent Issued: Mar. 22, 1921
Application Ser. No. 282236

6) Axial Piston Rotary Engine
Inventor: Dieter Voigt
Institute for Auto Studies—Asghen, Germany
Largest Technical College (Popular Science)
August 1980

7) Variable Compression Engine
J. B. Humphrey and W. H. Paul
Oregon State College, 1951

8) Variable Stroke Engine
Harvey Puliot (USA)
Sandia Labs, Livermore, Calif.
Energy Development
(Science and Mechanics), summer 1977

9) ICE Control System
Document Type and No. U.S. Pat. No. 4,108,136
Filing Date: May 26, 1976
Publication Date: Aug. 22, 1978

10) Hydraulic Combustion Accumulator
A propulsion system incorporating first and second hydraulic combustion accumulators
U.S. Pat. No. 5,647,734
Issued: Jul. 15, 1997

11) Accumulator Fuel-Injection system for ICE
U.S. Pat. No. 6,814,302
Filing Date: Apr. 29, 2004
Publication Date: Nov. 9, 2004

12) Canadian Intellectual Property Office
Patent: 1326793
App #. (21) 588175
Issued: Feb. 8, 1994
Filed: Jan. 13, 1989

13) Energy Accumulator and Internal Combustion Engine Starter
(Comprising Said Accumulator)
U.S. Pat. No. 4,441,466

14) United States Patent—Hunt
U.S. Pat. No. 3,080,942
March 1963-185/39

15) United States Patent—Fitzgerald
U.S. Pat. No. 2,004,431
1935-74/6

16) United States Patent—Hammerman
U.S. Pat. No. 3,205,881
1965-123/79

17) United States Patent—Laslo et. al
U.S. Pat. No. 4,108,136
May 26, 1976—Ford Motor Co.

18) United States Patent—Bodkin et. al
U.S. Pat. No. 3,308,907
March 1967-185/39

19) United States Patent—Brandstetter
U.S. Pat. No. 5,995,604
December 1976

Subject: Fuels—Energy derived from gasoline and used as I.C.E. fuel Gasoline, petrol, petroleum spirit produces thermal efficiency and volumetric quite effectively when the fuel mixture is properly mixed, compressed, and timely ignited. Professor Emeritus Mr. Joseph Pratt is one of the leading atheoretical experts on hydrocarbon. Until recently, Texas Panhandle was the leading oil supplier for lubricants, hydrocarbon fuels, etc. in the USA.

(The following chemical and scientific information by historian Mr. Joseph H. Pratt, University of Houston, Tex. Today's so-named “regular” gasoline is 8-carbon molecule octane and 7-carbon molecule heptane. Some years ago, scientists set the artificial scale, heptanes at 0 and octane at 100. So, octane at 8-carbon molecules, heptane at 7-carbon molecules, therefore regular, named 87, performs as if it were 87% octane and 13% heptanes and functions well for most low or moderate compression ratio engines. Gasoline vaporizes more easily, and will give more energy by weight or volume, than any other hydrocarbon.) The inordinate energy output of the Formula One G.P. engine further supports this claim of this fuel's potential.

In my judgment, a predominance of the ICE potential is misused or misplaced, perhaps as much as 60% (this does not mean 60% energy increase is available in addition to what already exists). If we examine the F1 V10 GP engine, we can get at least an objective assessment. Of course, there is no direct correlation or coefficient between EFR and PFR. The requirements are very different and the component and ancillary applications are dissimilar (this is not to say that a more efficient engine will not better respond to high performance application).

The now FIA abrogated F1-V10 Engine is something of a revelation. An F1 3-liter V10, engine naturally aspirated, on commercially available fuel at 15 to 18 thousand RPM will generate approximately 900 brake horsepower or 300 brake horsepower per liter of engine cubic capacity. (A former standard for performance from the naturally aspirated engine was 100 BHP per liter of engine cubic capacity.) These claims are made by people within the sport; however, their track performance would seem to substantiate these claims.

Re: the F1V10 engine our question is from what are we deriving all this energy, all the extra brake horsepower? In view of the fact that intake or breathing moment has been reduced by almost 50%, with exhaust and scavenging moment reduced by a similar constriction, and with friction losses, rotational turbulence by the crankshaft, rotary motion of the camshaft and flywheel substantially increased. These constraints must be calculated on the order of ×3 or 18,000 RPM. The only single advantage that this F1V10 engine has is the pneumatic closing of the valves, and mechanically that certainly cannot account for the enormous increase in brake horsepower output. As we know, it is the opening of the valves that absorbs the energy, not the closing. The pneumatic implementation for F1V10 is to prevent high RPM (valve float) renitence to closing or seating the valves. However, this power increase comes with a high fuel consumption of approximately 4 MPG, which makes it inappropriate for EFR application. The rational explanation for the gain in power output from the F1V10 engine is due to the very high RPM on the combustion or third cycle of this four-cycle engine. At this very high RPM, the thermodynamic pressure does not have sufficient time to become completely decreased or diminished while still having a favorable or prevalent angle on the crankpin journal. (The F1V10 engine is used by 20+ international competitors and is manufactured by about six different engine companies in accordance with FIA specifications and is subject to strict scrutiny by FIA authority.)

### Trigonal Linkage System

### Clarification

Trigonometric or trigonal linkage system
Trigonal
Threefold

Tri-go-nal (adj.): Relating to, or being the division of the hexagonal crystal system or the forms belonging to it characterized by a vertical, (or in this specification, angular) axis of threefold symmetry.

### Trigonal Linkage Coupling Method

### Clarification

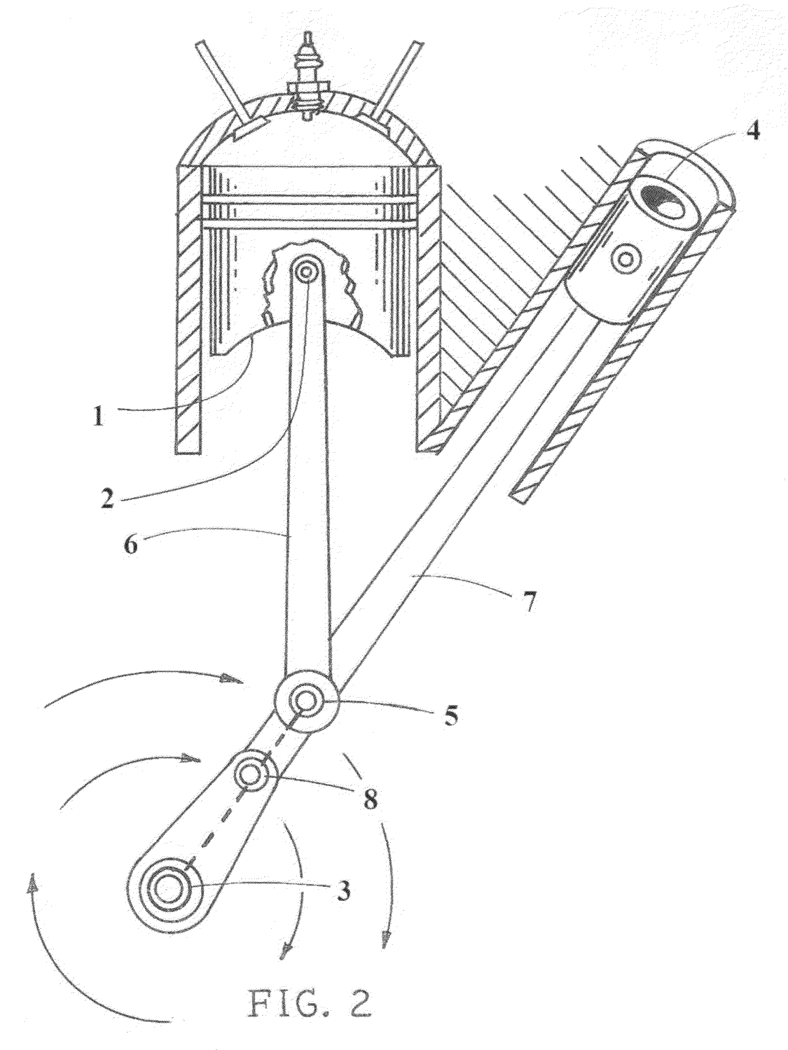

In this Illustration (FIG. 2), Connecting Rod No. 6 is coupled to the Connecting Rod Link No. 7 at a point before big end or crankpin journal. Precise point of attachment can be a choice for the constructor but should be in close proximity to the crankpin journal.

The manner or method by which this coupling is done must be tractable to accommodate linkage angle change (which is no more acute than existing mechanisms). The means can be by pin and bushing or any other sturdy mechanism to accommodate this vacillating coupling, by this means the maximum explosive force and thermodynamic pressure can be directed to a crankpin angle, wherein the crank journals are not in vertical or in-line formation, therefore forces and pressure can be applied to the rotary motion of crankshaft and flywheel assembly at a better leverage or dominant angle, while thermodynamic pressure has not yet become weakened or depreciated. By this means, heat and friction losses will be diminished, less fuel will be consumed, increased torque and horsepower will be axiomatic.

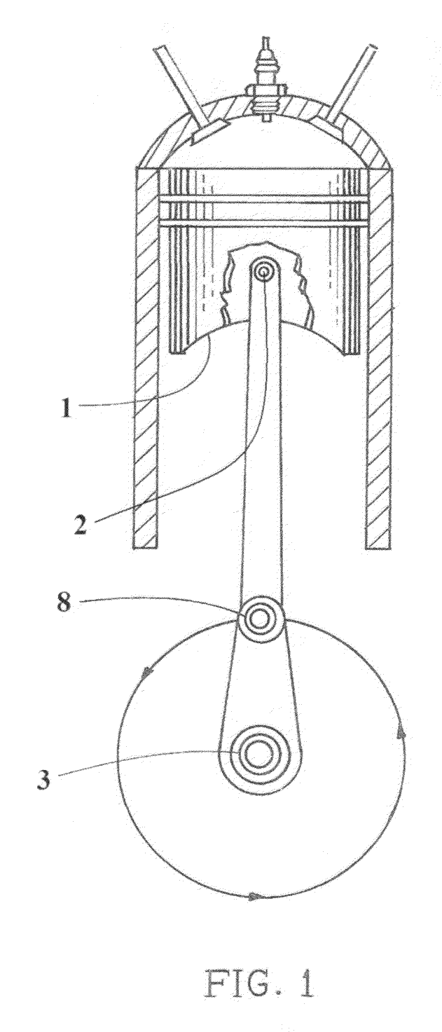

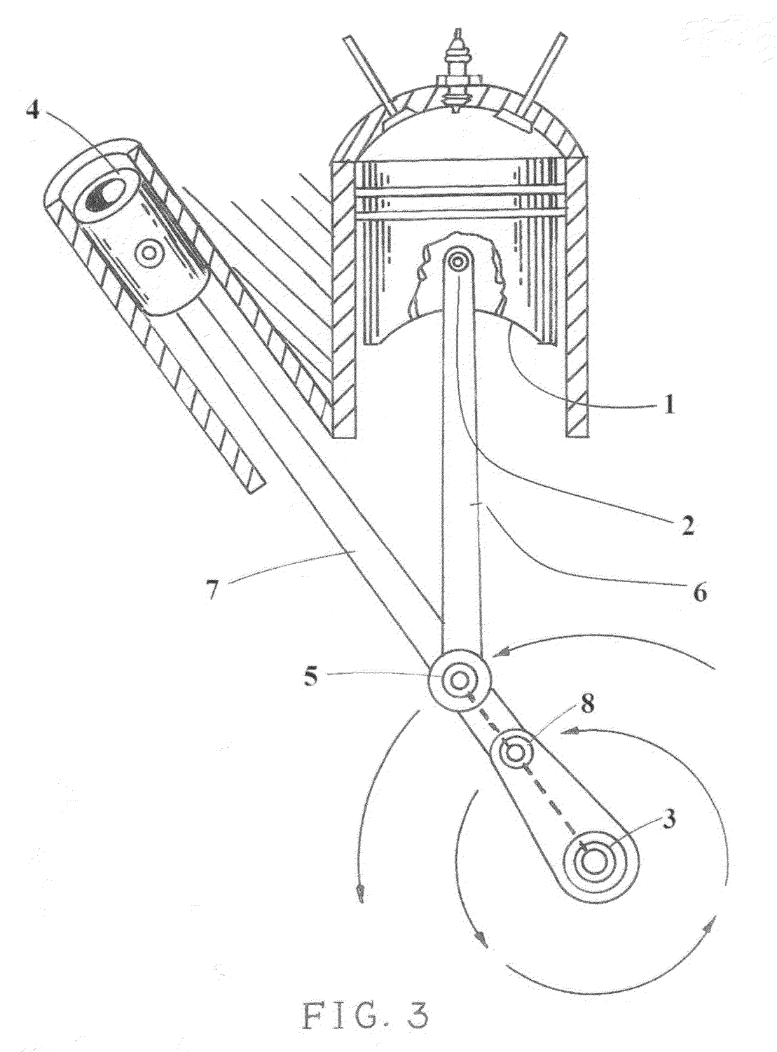

Legend to Figure Drawings and Reference Numbers

| | |
|---|---|
| FIG. 1 | No. 1—Standard piston with sealing rings and fitted wristpin |
| | No. 2—Wristpin Journal |
| | No. 3—Crankshaft main journal (counter-clockwise rotation) |
| FIG. 2 | No. 1—Power piston with sealing rings and fitted wristpin |
| | (clockwise rotation) |
| | No. 2—Wristpin journal |
| | No. 3—Crankshaft main journal |
| | No. 4—Guide piston (open ends, no sealing rings) |
| | No. 5—Trigonal Linkage coupling |
| | No. 6—Secondary link, or connecting rod |
| | No. 7—Primary link, or main connecting rod (clockwise |
| | rotation) |
| FIG. 3 | No. 1—Power piston with sealing rings, wristpin fitted |
| | No. 2—Wristpin Journal |
| | No. 3—Crankshaft main journal |
| | No. 4—Guide piston (open ends, no sealing rings) |
| | No. 5—Trigonal Linkage coupling |
| | No. 6—Secondary link or connecting rod |
| | No. 7—Primary link or main connecting rod (counter- |
| | clockwise rotation) |
| | No. 8—Crankpin journal (counter-clockwise rotation)* |
| FIG. 4 | Graphics on page 14 w/legend and reference numbers |

*No. 8 was in original submission to USPTO but was inadmissible as it was on page with the corresponding graphic

1. Trigonal linkage system incorporating two cylinders coupled to each other by their respective rod linkage and attached to crankpin journal

2. Whereby guide may be by open end piston, block slider, ball or roller bearing, or any low friction material

3. Whereby one cylinder may be unaided or disjunctive or not power charged, functioning only as a guide where attachment point may be optional but best in close proximity to crankpin journal

4. The object of this patent application is to apply maximum thermodynamic force at a degree point at least 15° clockwise past (or after) Top Dead Center on crankpin journal
